(19) United States
(12) Patent Application Publication
(10) Pub. No.: US 2025/0332610 A1
(43) Pub. Date: Oct. 30, 2025

(54) APPLICATOR

(71) Applicant: Can-Am Tool Corp., STURGEON COUNTY (CA)

(72) Inventors: Hermann BASLER, Parkland Country AB (CA); Micah WARKENTIN, Edmonton (CA)

(21) Appl. No.: 18/646,584

(22) Filed: Apr. 25, 2024

(51) Int. Cl. B05C 17/01; B05C 17/005; B65D 83/00

(52) U.S. Cl. CPC B05C 17/0116; B05C 17/00593; B65D 83/763

(57) ABSTRACT

An applicator for and method of applying a material, and a piston assembly for the applicator. A piston assembly of the applicator is movably engaged within a housing to form a reservoir that is expandable and contractable to, respectively, draw into and push out from the reservoir the material via an opening during, respectively, suction and pressure phases of the applicator. The piston assembly includes an outer seal to prevent ingress of fluid towards the reservoir from an outer side of the piston assembly during the suction phase and an inner seal disposed between the outer seal and the reservoir to prevent egress of material out of the reservoir into a cavity formed between the housing and the inner and outer seals, during the pressure phase. The outer seal moves freely as the applicator is moved to the pressure phase to open the cavity for pressure equalization to prevent suction.

### TECHNICAL FIELD

The disclosure relates generally to devices for finishing walls, and more particularly to applicators for applying material.

### BACKGROUND

Installing drywall panels and finishing walls includes applying building materials, such as drywall compound, also referred to as drywall mud or plaster. These materials may be applied between drywall boards, over drywall tape, along corners between drywall boards forming separate (non-parallel) walls, over corner beading, and/or in other places. In some cases, plaster may need to be applied over an entire wall.

Building materials for finishing walls, such as drywall mud, typically include gypsum, lime, and hydrating components. The resulting compounds may have complex rheology, e.g. the compounds may exhibit shear-thinning and thixotropic behaviour, which varies as the compounds dries. As such, applying such materials in a consistent manner to finish walls to a high standard can be both difficult and time-consuming, particularly at corners between two mutually perpendicular (or non-parallel) walls and other locations between drywall boards.

Several types of applicators for applying building material have been developed to improve efficiency and quality of wall finishing. In general, such applicators including a dispenser that dispenses building material in a relatively well-controlled manner for applying directly on to a work surface. For instance, the dispenser may include a nozzle for dispensing drywall mud out of a corner tool that is dimensioned to form a corner shape out of the drywall compound by pressing the drywall compound between the corner tool and a corner bead or an edge between non-parallel walls.

In one example applicator, drywall mud is received in a material reservoir through an inlet thereof and is then pushed out of the material reservoir through an outlet thereof connected to a push-to-open valve assembly of an applicator head. Pushing the applicator head against a work surface activates the push-to-open valve assembly which allows the drywall mud to flow out of the applicator head. A plunger is disposed in the reservoir and employed to push and dispense the drywall mud out of the applicator head, i.e. to apply pressure against the drywall mud. The plunger is connected to a piston of a pressurized cylinder. When a release lever is depressed, gas and/or spring pressure within the pressurized cylinder pushes the piston, which in turn pushes the plunger against the drywall mud for pushing the drywall mud out of the applicator head. The forces required to push the drywall mud via the plunger may vary and may be unpredictable for several reasons, including complex rheology of drywall compound and drying-induced changes thereof. Large springs and/or excessively high fluid pressures, along with valve assemblies for achieving drywall compound flow control, may need to be deployed to ensure consistent outflow of drywall mud from the applicator head. In some circumstances, fluid pressure may build up in the material reservoir which may then act against the force applied by the plunger via the pressurized cylinder. In general, flow devices for flowing drywall compound are difficult to design compared to flow devices for Newtonian fluids or other materials with well-controlled and simple behaviour, and as such efficiently achieving high quality wall finishes can be challenging.

Improvements are desired to overcome some of the described, indicated, and/or suggested drawbacks in devices and methods for applying materials to work surfaces.

### SUMMARY

In applicators with a plunger or other movable disc actuatable by a piston rod and configured to separate a reservoir of drywall compound or other material from an outer portion of the applicator, it is desirable to seal off the reservoir where the plunger meets the reservoir to prevent egress of material therefrom and ingress of gas thereinto. For example, preventing ingress of gas into the reservoir that would otherwise cause pressure equalization between the ambient and the reservoir is important in applicators where material is drawn into the applicator by expanding the reservoir to create suction for suctioning in the material (the suction phase). Similarly, when the reservoir is being contracted to push out the material (the pressure phase), it is desirable to prevent reverse flow of material via the plunger. Sealing can be achieved by sealing elements that prevent drywall mud from leaking across the plunger and out of the reservoir. However, establishing tight sealing of the reservoir tends makes moving the plunger difficult. For example, using a two-sided piston cup seal that defines two opposing sealing sides with a fixed distance therebetween can make pushing the piston rod difficult during the pressure phase because of suction on to the housing of an intermediate portion of the seal between the two sealing sides. This suction is introduced during the suction phase and is not released once the applicator is in the pressure phase. Introducing bleed hole(s) can allow release of this suction but such bleed hole(s) tend to get clogged with material, which hampers release of suction. During the suction phase, such bleed hole(s) may allow gas buildup in the reservoir, e.g. causing infiltration of such gas into and onto the material in the reservoir and/or causing substantially large gas pockets or bubbles forming in the reservoir.

Using two separate seals coupled together in series so as to have some predetermined play between them allows the outer seal to at least partially freely move as the applicator is taken from the suction phase to the pressure phase. This free movement in a clearance, defined by range of the predetermined play, allows at least momentary fluid communication between the ambient air and a cavity, or gap, formed between the seals and the sealing surface(s). This causes pressure equalization of the cavity, or gap, and prevents undue suction of walls of the seal against walls of the sealing surface while avoiding compromising the reservoir-side seal.

In an aspect, the disclosure describes an applicator for applying a material. The applicator also includes a housing defining an opening for receiving and extruding the material; and a piston assembly movably engaged within the housing to form a reservoir that is expandable to draw the material into the reservoir via the opening during a suction phase and that is contractable to push material out of the reservoir via the opening during a pressure phase, the piston assembly including an outer seal to prevent ingress of fluid towards the reservoir from an outer side of the piston assembly in the housing opposite the reservoir, during the suction phase, an inner seal disposed between the outer seal and the reservoir to prevent egress of material out of the reservoir into a cavity formed between the housing and the inner and outer seals, during the pressure phase, a piston rod to actuate the piston assembly and operatively associated with the inner and outer seals, the piston rod being operable to close the cavity by the outer seal during the suction phase to allow suction of the outer seal by the cavity, the piston rod being operable to move relative to the outer seal as the applicator is moved to the pressure phase to open the cavity to the outer side for pressure equalization of the cavity to prevent suction of the outer seal by the cavity during the pressure phase.

Implementations may include one or more of the following features. Such implementations may include combinations of any one or more of the following features. The applicator where the piston assembly is configured to couple the inner and outer seals to each other via one or more interlocking connections with predetermined play so as to open the cavity between the inner and outer seals as the piston assembly is moved from the suction phase to the pressure phase to allow flow communication between the outer side and the cavity and so as to close the cavity between the inner and outer seals during the suction phase to allow suction of the outer seal by the cavity. The one or more interlocking connections includes an interlocking connection between the outer seal and a disc assembly configured to captively retain the outer seal between the housing and the disc assembly, the disc assembly being coupled to the piston rod, the piston rod extending outwardly from the housing to allow an operator to actuate the piston assembly to achieve the pressure phase by pushing on the piston rod and to achieve the suction phase by pulling on the piston rod. The disc assembly includes an inner disc suitable to engage with an external face of the inner seal during the pressure phase, an outer disc suitable to engage with an external face of the outer seal during the suction phase, and a middle disc coupling the inner and outer discs to each other and disposed between internal faces of the inner and outer seals to engage with the internal face of the inner seal during the pressure phase to at least partially sandwich the inner seal between the inner disc and the middle disc and to engage with the internal face of the outer seal during the suction phase to at least partially sandwich the outer seal between the outer disc and the middle disc, the disc assembly being dimensioned so as to allow disengagement of the middle disc from the outer seal as the applicator is moved to the pressure phase to allow movement of the outer seal between the middle disc and the outer disc to permit ingress of fluid into the cavity for pressure equalization. The external and internal faces of the inner seal are opposing faces of a lip of the inner seal, the external and internal faces of the outer seal are opposing faces of a lip of the outer seal, a lip of the inner disc engages with the external face of the inner seal such that the lip of the inner seal is suitable to be sandwiched between the lip of the inner disc and an inner face of the middle disc engaged with the internal face of the inner seal, a lip of the outer disc engages with the external face of the outer face such that the lip of the outer seal is suitable to be sandwiched between the lip of the outer disc and an outer face of the middle disc engaged with the internal face of the outer seal, and where the lip of the outer seal is dimensioned relative to the outer disc so as to be captively retained, with the predetermined play, between the outer face of the middle disc and the lip of the outer disc. The inner disc, the middle disc, and the outer disc are rigidly integrally coupled to each other, the movement of the disc assembly away from the reservoir during the suction phase causing sealing engagement of the outer face of the middle disc with the internal face of the outer seal to seal the cavity, the movement of the disc assembly towards the reservoir during the pressure phase causing engagement of the lip of the outer disc with the external face of the outer seal, such that movement of the disc assembly from the suction phase to the pressure phase causes disengagement of the lip of the outer seal from the outer and middle discs to open the cavity for pressure equalization. The inner seal is a first piston cup seal and the outer seal is a second piston cup seal, a cup depression of the first piston cup seal positioned to receive the material to achieve sealing by pressurization of the cup depression of the first piston cup seal during the pressure phase, a cup depression of the second piston cup seal positioned to receive fluid from the outer side of the piston assembly to achieve sealing by pressurization of the cup depression of the second piston cup seal during the suction phase. The inner and outer seals each have a corresponding external end suitable to sealingly engage with the housing, the inner and outer seals extending radially inwardly and towards each other from the corresponding external ends to form the cavity between the housing and the inner and outer seals and to allow pressure applied to sidewalls of the inner and outer seals opposite the cavity to vary sealing of the corresponding external ends of the inner and outer seals against the housing. The inner and outer seals extend smoothly concavely towards each other from their external ends to form the cavity between the housing and the inner and outer seals. The piston rod extends outwardly from the housing to allow an operator to actuate the piston assembly to achieve the pressure phase by pushing on the piston rod and to achieve a suction phase by pulling on the piston rod, the housing being elongated between a first end and a second end, the opening of the housing disposed at the first end, a cap closing the housing disposed at the second end and configured to receive the piston rod to allow slidable movement of the piston rod in the cap. The inner seal is coupled to the piston rod, the piston rod extending outwardly from the housing to allow an operator to actuate the piston assembly to achieve the pressure phase by pushing on the piston rod and to achieve the suction phase by pulling on the piston rod, and the inner and outer seals are disposed adjacent to one another to form the cavity and are interlocked to captively retain each other such that the inner and outer seals are co-movable by movement of the piston rod and are movable relative to each other to permit ingress of fluid for pressure equalization of the cavity as the piston rod is pushed into the housing. The material is drywall compound, and the opening is an aperture coupled to a finishing tool suitable to shape the drywall compound being extruded from the aperture. The inner and outer seals are concentrically arranged in series about a longitudinal axis of the housing and retained within the housing by frictional engagement with an inner surface of the housing, the inner and outer seals extending radially inwardly and longitudinally towards each other from a corresponding external ends towards corresponding circumferentially and radially inwardly extending lips to form the cavity, each of the corresponding circumferentially and radially inwardly extending lips defining corresponding internal and external faces at least partially lateral to the longitudinal axis and suitable for forming one or more interlocking connections with predetermined play for coupling the inner and outer seals to each other so as to open the cavity as the piston assembly is moved from the suction phase to the pressure phase to allow flow communication between the outer side and the cavity.

In an aspect, the disclosure describes a method of applying a material. The method also includes expanding a reservoir to draw in the material via an opening of the reservoir and to draw in fluid from a cavity formed between an inner seal adjacent to the reservoir and an outer seal distal from the reservoir relative to the inner seal so as to cause suction of the outer seal by the cavity; and contracting the reservoir by drawing the inner seal away from the outer seal to open the cavity to cause pressure equalization across the outer seal to release suction of the outer seal by the cavity and to push the material out of the opening to apply the material via the opening.

Implementations may include one or more of the following features. Such implementations may include combinations of any one or more of the following features. The method where the outer seal is a first piston cup seal, and the inner seal is a second piston cup seal. The inner and outer seals are spaced apart from each other and coupled to each other via a disc assembly, and where contracting the reservoir by drawing the inner seal away from the outer seal includes pushing the inner seal away from the outer seal using a middle disc of the disc assembly to open the cavity, and may include: retaining, captively, the outer seal between the middle disc and an outer disc of the disc assembly so as to allow movement of the outer seal, the outer disc being coupled to the middle disc. Contracting the reservoir by drawing the inner seal away from the outer seal includes displacing the inner and outer seals relative to each other to open the cavity to cause pressure equalization.

In an aspect, the disclosure describes a piston assembly for an applicator for applying material. The piston assembly also includes an outer seal to prevent ingress of fluid towards the reservoir from a side of the housing opposite the reservoir relative to the piston assembly, during the suction phase; and an inner seal disposed between the outer seal and the reservoir to prevent egress of material out of the reservoir into a cavity formed between the housing and the inner and outer seals, during the pressure phase, the outer seal being at least partially freely movable as the applicator is being moved to the pressure phase to open the cavity between the inner and outer seals to allow flow communication between the side of the housing and the cavity for pressure equalization of the cavity to prevent suction of the outer seal by the cavity during the pressure phase and being configured to close the cavity between the inner and outer seals during the suction phase to allow suction of the outer seal by the cavity.

Implementations may include one or more of the following features. Such implementations may include combinations of any one or more of the following features. The piston assembly where the inner seal and outer seals are adapted to interlock with each other with predetermined play between the inner and outer seals so as to open the cavity between the inner and outer seals as the applicator is moved from the suction phase to the pressure phase to allow flow communication between the side and the cavity, and so as to close the cavity between the inner and outer seals during the suction phase to allow suction of the outer seal by the cavity. The inner and outer seals each have a corresponding external end suitable to sealingly engage with the housing, the inner and outer seals are piston cup seals extending radially inwardly and towards each other from their corresponding external ends to form the cavity between the housing and the inner and outer seals. The inner and outer seals are coupled to each other via one or more interlocking connections with predetermined play to open the cavity as the applicator is moved from the suction phase to the pressure phase to allow flow communication between the side and the cavity, the one or more interlocking connections including an interlocking connection between the outer seal and a disc assembly configured to captively retain the outer seal between the housing and the disc assembly, the disc assembly being coupled to a piston rod extending outwardly from the housing to allow an operator to actuate the applicator to achieve the pressure phase by pushing on the piston rod and to achieve the suction phase by pulling on the piston rod. The inner seal is a first piston cup seal and the outer seal is a second piston cup seal, a cup depression of the first piston cup seal positioned to receive the material to achieve sealing by pressurization of the cup depression of the first piston cup seal ring the pressure phase, a cup depression of the second piston cup seal positioned to receive fluid from the side to achieve sealing by pressurization of the cup depression of the second piston cup seal during the suction phase.

Embodiments can include combinations of the above features.

Further details of these and other aspects of the subject matter of this application will be apparent from the detailed description included below and the drawings.

### DESCRIPTION OF THE DRAWINGS

Reference is now made to the accompanying drawings, in which:

FIG. 1A is a side elevation view of an applicator disposed in a pail for drawing in material therefrom, in accordance with an embodiment;

FIG. 1B is a perspective view of the applicator equipped with a corner tool engaged with a wall corner, in accordance with an embodiment.

FIG. 2A is a side elevation view of the applicator, in accordance with an embodiment;

FIG. 2B is a cross-sectional view of the applicator along the line 2B-2B in FIG. 2B, in accordance with an embodiment;

FIG. 3A is an enlarged cross-sectional view of region 3 in FIG. 2B during the suction phase, in accordance with an embodiment;

FIG. 3B is an enlarged cross-sectional view of the region 3 in FIG. 2B as the applicator 100 moves from the pressure phase to the suction phase, in accordance with an embodiment;

FIG. 3C is an enlarged cross-sectional view of the region 3 in FIG. 2B during the pressure phase, in accordance with an embodiment;

FIG. 4 is an enlarged cross-sectional view of the region 4 in FIG. 3B, in accordance with an embodiment;

FIG. 5 is an enlarged cross-sectional view of a piston assembly of an applicator, in accordance with another embodiment; and

FIG. 6 is a flowchart of a method of applying a material, in accordance with an embodiment.

### DETAILED DESCRIPTION

The following disclosure relates to applicators. In some embodiments, the devices and methods disclosed herein can facilitate better sealing and/or greater ease of use of applicators.

In some embodiments, the applicator has a middle disc between two elastomeric piston cups that are separate and not of unitary construction. Each piston cup may be held in place by a separate disc or cap, e.g. by means of interlocking connections therebetween. One of the piston cups is disposed on an inner side of the applicator proximal to a reservoir of material thereof and one of the piston cups is positioned on an outer side of the applicator distal from the reservoir relative to the other piston cup. Each piston cup may provide a seal in the direction that it faces. The cap on the outer side may have increased or relatively large clearance to the piston cup it is configured to retain. A threaded fastener and washer may fix the assembly of piston cups and the middle disc to an internally threaded plug on an end of a piston rod. As drywall compound is drawn into the reservoir and negative pressure is created therein, air in a cavity defined between the two piston cups and the sealing surface, i.e. an inner wall of a housing of the applicator, is drawn past the inner side piston cup leaving a vacuum in the cavity which causes suction. As the piston rod is then pushed, the outer cap is disengaged from its cup due to the clearance between them and an air passage between the ambient atmosphere and the cavity forms, at least momentarily until re-engagement during the pressure phase. This air passage allows the ambient air to pass into the cavity and release the vacuum, which makes the piston easier to push by an operator.

Aspects of various embodiments are described in relation to the figures.

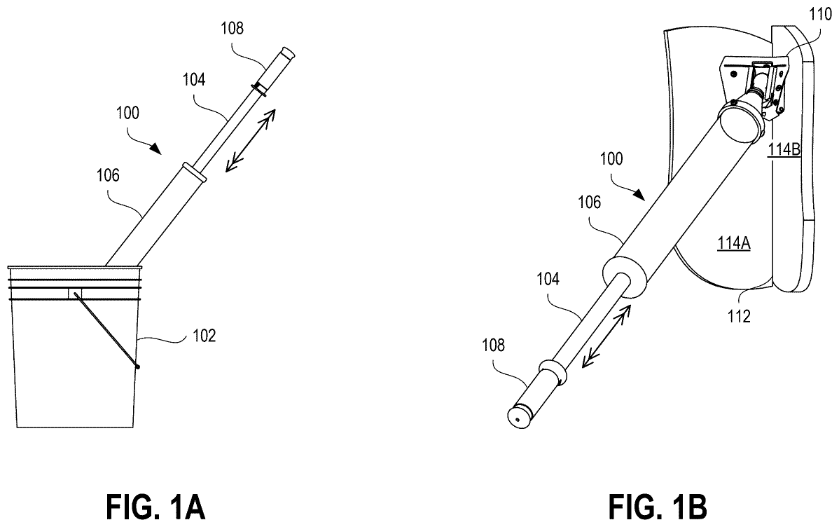

FIG. 1A is a side elevation view of an applicator 100 disposed in a pail 102 for drawing in material therefrom, in accordance with an embodiment.

In some embodiments, the material is a finishing material, such as may be useful for finishing walls and other surfaces of a building or on furniture, and the application of which is required to conform to finishing requirements. For example, the material may be drywall compound (also referred to as drywall mud) or gypsum that is desirably applied uniformly over a wall. In some embodiments, the material may exhibit complex rheological behaviour that introduces difficulties in achieving a desired finishing. For example, certain compositions may exhibit viscoelastic, thixotropic, and/or shear-thinning behaviour, that may also be sensitive to the level of hydration of the composition and other factors. It is understood that the material is flowable so as to be suitable to be drawn in and pushed out of the applicator, e.g. the material may be a liquid or flowable soft matter.

As shown in FIG. 1A, the applicator 100 has a piston rod 104 that can be pulled from a housing 106 using a handle 108 to create a vacuum or low pressure therein to draw in the material from the pail 102. A direction of movement of the piston rod 104 into and out of the housing 106 is indicated by the double-headed double arrow. The applicator 100, as shown in FIG. 1A, is in a suction phase thereof, wherein the applicator 100 is configured to suction the material from the pail 102. In some embodiments, the housing 106 may be cylindrical. For example, in some embodiments, cylindrical housings may facilitate flow of material through the applicator 100.

FIG. 1B is a perspective view of the applicator 100 equipped with a corner tool 110 engaged with a wall corner 112 so as to receive the material being pushed out of the applicator 100 to apply the material to the wall corner 112, in accordance with an embodiment. The corner tool 110 may facilitate smoothing and filling in gaps in the corners.

The corner tool 110 may be a corner finishing tool. The corner tool 110 may snap-on or snap-fitted to an end of the applicator. The tool is positioned at the wall corner 112 defined between adjacent sheets 114A, 114B of drywall (cutaway for clarity). The handle 108 is pushed to supply the material to the corner tool 110 and fill and smooth a gap between the adjacent sheets 114A, 114B of drywall. The applicator 100, as shown in FIG. 1B, is in a pressure phase thereof, wherein the applicator 100 is configured to push out the material from the pail 102.

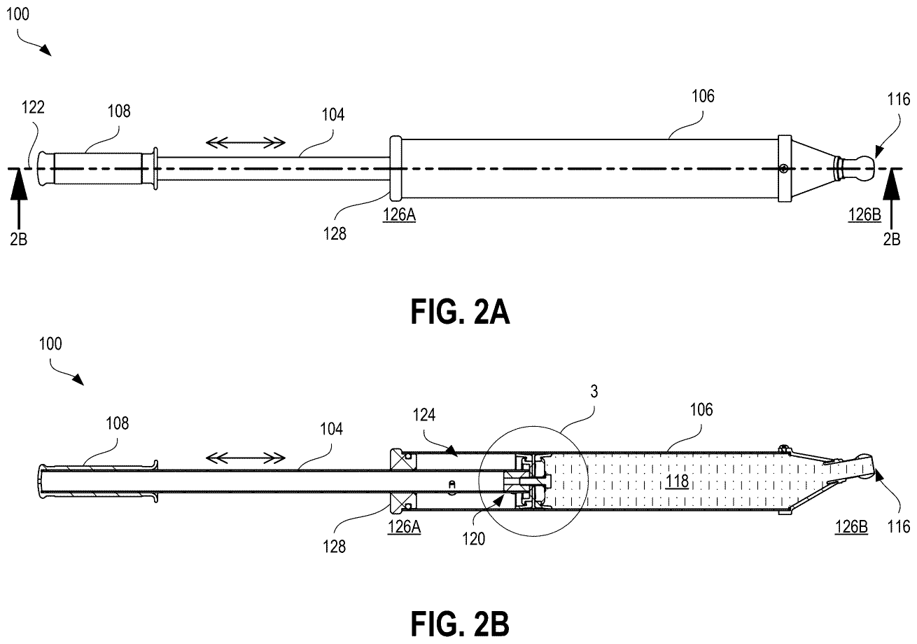

FIG. 2A is a side elevation view of the applicator 100, in accordance with an embodiment.

FIG. 2B is a cross-sectional view of the applicator 100 along the line 2B-2B in FIG. 2B, in accordance with an embodiment.

In FIGS. 2A-2B, the applicator 100 is shown without a tool.

The housing 106 may be generally elongated between opposing ends 126A, 126B. In various embodiments, a cap 128 closing the housing 106 may be disposed at a first end 126A of these ends. The cap 128 may be configured to receive the piston rod 104 to allow slidable movement of the piston rod 104 therein. An opening 116 of the housing may be disposed at a second end 126B of these ends. The opening 116 may be suitable for receiving the material during the suction phase, e.g. as shown in FIG. 1A, and for extruding the material during the pressure phase, e.g. as shown in FIG. 1B. In various embodiments, the opening 116 may be an aperture coupled to a finishing tool suitable to shape the material, such as drywall compound, being extruded from the aperture.

In FIG. 2B, a reservoir 118 of the applicator 100 formed in the housing 106 is shown filled with the material. The material is drawn into and out of the reservoir via the opening 116.

As shown in FIG. 2B, a piston assembly 120 of the applicator 100 is movably engaged within the housing to form the reservoir 118 therein. The reservoir 118 is expandable to draw the material thereinto via the opening 116 during the suction phase by movement of the piston assembly 120 out of the housing 106. Similarly, the reservoir 118 is contractable to push material out of the reservoir 118 via the opening 116 during the pressure phase by movement of the piston assembly 120 into the housing 106. As indicated by the double-headed double arrows in FIGS. 2A-2B, the movement of the piston assembly 120 out of and into the housing 106 may be oriented parallel to a longitudinal axis 122.

The piston assembly 120 is coupled to the piston rod 104. The piston rod 104 extends outwardly from the housing 106 through an outer side 124 of the piston assembly to allow an operator to actuate the piston assembly to achieve the pressure phase by pushing on the piston rod 104 and to achieve a suction phase by pulling on the piston rod 104. The outer side 124 may be a side not exposed to the material in the reservoir 118.

In various embodiments, the piston assembly 120 may be disposed within the housing 106 during both suction and pressure phases. An outer side 124 of the piston assembly 120 may be defined in the housing 106 opposite the reservoir 118.

In various embodiments, the housing 106 are relatively hard, e.g. they may be constructed or composed of hard plastic, steel, aluminium, or other metal.

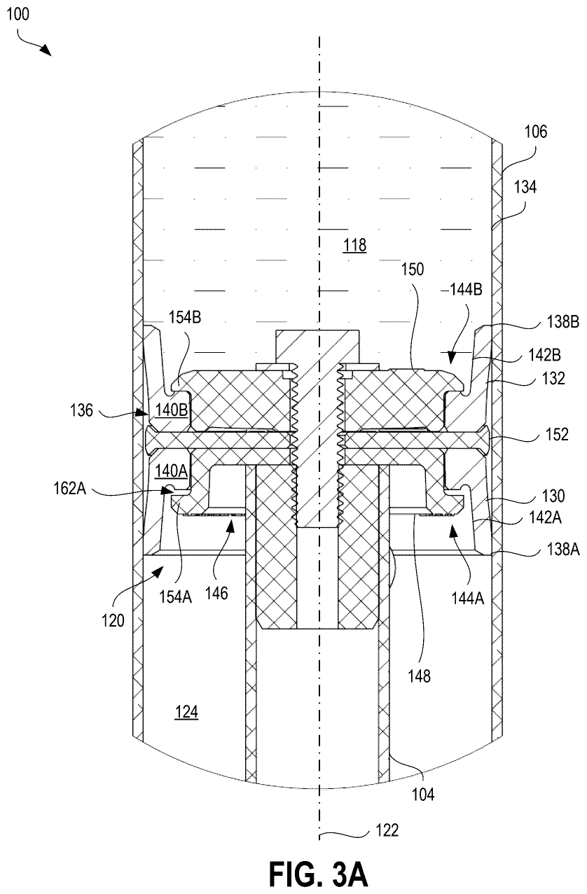

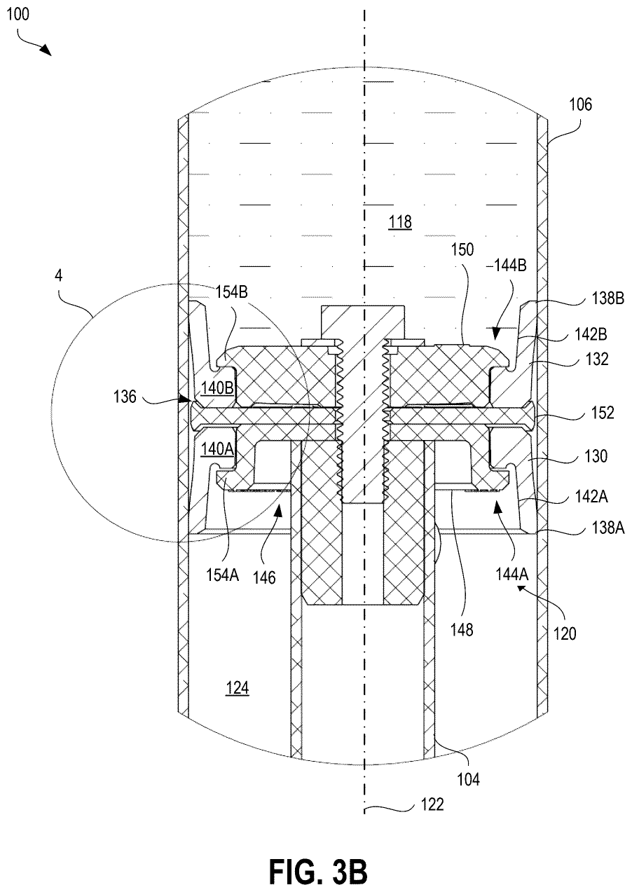

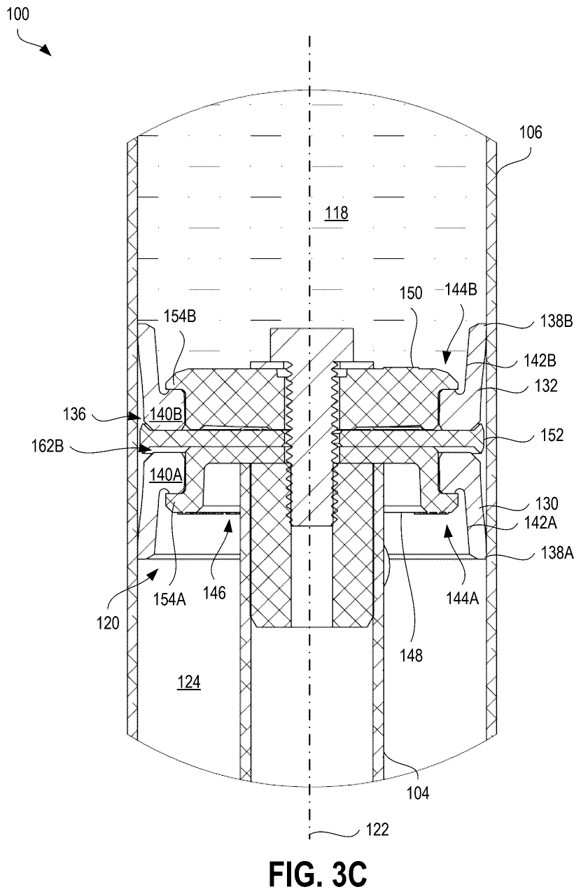

FIG. 3A is an enlarged cross-sectional view of region 3 in FIG. 2B during the suction phase, in accordance with an embodiment.

FIG. 3B is an enlarged cross-sectional view of the region 3 in FIG. 2B as the applicator 100 moves from the pressure phase to the suction phase, in accordance with an embodiment.

FIG. 3C is an enlarged cross-sectional view of the region 3 in FIG. 2B during the pressure phase, in accordance with an embodiment.

Referring to FIGS. 3A-3C, the piston assembly 120 of the applicator 100 includes an outer seal 130 and an inner seal 132 disposed between the outer seal 130 and the reservoir 118. The inner seal 132 is positioned at an inner side of the piston assembly 120 proximal to, and facing, the reservoir 118 while the outer seal 130 is positioned at the outer side 124 of the piston assembly 120 distal from, and facing away from, the reservoir 118. The piston assembly 120 is configured to couple the outer seal 130 to the inner seal 132 via one or more interlocking connections 144A, 144B with predetermined play so that the outer and inner seals 130, 132 captively retained in the in the one or more interlocking connections 144A, 144B and connected to each other while being allowed to, at least in some configurations, move relative to each other. The predetermined play may be associated with clearance 162A in FIG. 3A on one side of the outer seal 130, clearance 162B in FIG. 3C on an opposite side of the outer seal 130, and clearances in FIG. 3B on both sides of the outer seal 130.

As shown in the embodiments of FIGS. 3A-3C, the inner side of the piston assembly 120 may define at least part of the reservoir 118. The inner seal 132 and the outer seal 130 may be concentrically arranged in series about the longitudinal axis 122 of the housing 106 and retained therein by frictional engagement with an inner surface 134 of the housing 106. For example, as shown in the embodiments of FIGS. 3A-3C, the inner seal 132 and the outer seal 130 may each be substantially continuously or discretely axisymmetric about the longitudinal axis 122. The inner surface 134 may be a sealing surface against which the outer and inner seals 130, 132 provide sealing.

A cavity 136 is formed between the housing 106, the inner seal 132, and the outer seal 130. In embodiments such as those shown in FIGS. 3A-3C, the outer seal 130 and inner seal 132 extend radially (lateral to the longitudinal axis 122) inwardly and longitudinally (along the longitudinal axis 122) towards each other, e.g. in a smoothly concave manner has shown in FIGS. 3A-3C, from corresponding external ends 138A, 138B thereof towards corresponding lips 140A, 140B to form the cavity 136. The external ends 138A, 138B of, respectively, the outer seal 130 and the inner seal 132, are suitable to sealingly engage with the housing 106. The lips 140A, 140B are circumferentially and radially inwardly extending.

The outer seal 130 and the inner seal 132 are operatively associated with the piston rod 104. The piston rod 104 may be configured to operate the outer seal 130 and the inner seal 132 by movement of the piston rod 104 relative to the outer seal 130 and/or the inner seal 132. In particular, operation of the piston rod 104 by movement of the piston rod 104 relative to the outer seal 130 may allow selective opening of the cavity 136 for pressure equalization or sealing of the cavity 136 for sealing suction by cavity 136.

In some embodiments, as shown in FIGS. 3A-3C, sidewalls 142A, 142B of the outer and inner seals 130, 132 extend, on a side opposite the cavity, between the external ends 138A, 138B and the corresponding lips 140A, 140B. In various embodiments, the sidewalls 142A, 142B may be incurvate. In various embodiments, the sidewalls 142A, 142B may be defined by tubular walls or walls of a frusto-conical or concave shape. In various embodiments, the outer and inner seals 130, 132 may be piston cup seals defining cup depressions defined radially inwardly of the sidewalls 142A, 142B.

In the embodiment of FIGS. 3A-3C, as (fluid or material) pressure applied to sidewalls 142A, 142B is varied, relative to the pressure in the cavity 136, the sealing engagement of the external ends 138A, 138B with the inner surface 134 of the housing 106 may be varied. For example, if the pressure on one of the sidewalls 142A, 142B is lower then the pressure in the cavity 136, a net force results on the corresponding (outer or inner) seal that draws or suctions the corresponding external end (of the external ends 138A, 138B) away from the inner surface 134, to thereby weaken sealing engagement of the external end with the inner surface 134. Such a net force, if sufficiently large, may allow egress of fluid out of the cavity 136 towards the sidewall and/or establish flow communication across the seal for pressure equalization of the cavity 136. Similarly, if the pressure on a sidewall is higher than the pressure in the cavity 136, a net force results on the corresponding (inner or outer) seal that pushes or pressurizes the corresponding external end towards or on to the inner surface 134, to thereby strengthen sealing engagement of the external end with the inner surface 134.

In various embodiments, sealing engagement of one of the inner or outer seals 132, 130 may be increased by increasing frictional force between that seal and the inner surface 134. The frictional force is dependent on a force applied to the corresponding external end at least partially normal to the inner surface 134. This force depends on the pressure difference across the seal, i.e. a pressure differential between the corresponding sidewall and the cavity 136, and the baseline stress applied by the seal against the inner surface 134. The baseline stress may be caused by a stressed state of the seal in the housing 106, which may be present without a pressure difference across the seal. For example, the stressed state may be caused by (material strain due to) interference between the seal and the housing 106 and may thereby be related to the dimensions of the seal relative to the dimensions of the housing 106. The material of the seal may be chosen to achieve a desired relationship between stress and strain and/or to achieved desired fatigue behaviour, e.g. resilience under multiple cycles. For example, the seal may be constructed of an elastomeric material or other resilient material. Relative to the seals, the housing 106 may be constructed of a relatively hard material such as hard plastic, steel, aluminium, or other metal.

During the suction phase of the applicator 100 (or of the piston assembly 120), the piston assembly 120, and in particular, the outer seal 130 and the inner seal 132 together (or sealing assembly), is configured to close the cavity 136 between the outer seal 130 and the inner seal 132 to allow suction of the outer seal 130 by the cavity 136. As shown in FIG. 3A, the cup depression of the outer seal 130 is positioned to receive air, or any other liquid or gaseous fluid that may be present on the outer side 124, from the outer side 124 of the piston assembly 120 on to the sidewall 142A such that the pressure against the sidewall 142A, relative to the pressure in the cavity 136, causes the external end 138A to be pushed against the inner surface 134. As such, sealing is achieved by pressurization of the outer seal 130, i.e. the cup depression thereof, against the inner surface 134 to prevent ingress of the fluid towards the reservoir 118 from the outer side 124 via the cavity 136. During the suction phase, the inner seal 132 remains coupled to the outer seal 130 via the one or more interlocking connections 144A, 144B and is positioned to be movable relative to the outer seal 130, e.g. as the applicator 100 is moved to the pressure phase, via the predetermined play.

During the pressure phase of the applicator 100 (or of the piston assembly 120) shown in FIG. 3C, the cup depression of the inner seal 132 is positioned to receive the material in the reservoir 118 against the sidewall 142B such that the pressure against the sidewall 142B, relative to the pressure in the cavity 136, causes the external end 138B to be pushed against the inner surface 134. As such, sealing is achieved by pressurization of the inner seal 132, i.e. the cup depression thereof, against the inner surface 134 to prevent egress of material out of the reservoir 118 into the cavity 136. During the pressure phase, the inner seal 132 remains coupled to the outer seal 130 via the one or more interlocking connections 144A, 144B and is positioned to be movable relative to the outer seal 130, e.g. as the applicator 100 is moved to the suction phase, via the predetermined play.

As the applicator 100 is moved to the pressure phase, as shown in FIG. 3B, e.g. from the suction phase, the outer seal 130 is at least partially freely movable to open the cavity 136 between the outer seal 130 and the inner seal 132. In various embodiments, the cavity 136 may be opened by movement of the outer seal 130 within the predetermined play so that it is positioned in-between the opposing limits of the predetermined play of the one or more interlocking connections 144A, 144B. As a result, flow paths into the cavity 136 may be opened to allow flow communication between the outer side 124 and the cavity 136. The flow communication allows for pressure equalization of the cavity 136 so as to prevent suction of the outer seal 130 by the cavity 136 during, and as the applicator 100 is moved into, the pressure phase. Advantageously, an operator may then extrude the material out of the opening 116 with greater ease.

As the applicator 100 is moved from the pressure phase to the suction phase, reversal of the stroke direction causes physical deformation of the outer seal 130 to allow pressure equalization of the cavity 136.

As shown in FIG. 3C, once the applicator 100 is moved to the pressure phase, the cavity 136 may be closed. In some embodiments, the cavity 136 remains open during the pressure phase. Since sealing during the pressure phase may be provided by the inner seal 132, it may not be necessary for the outer seal 130 to also establish sealing engagement with the inner surface 134.

In various embodiments, the one or more interlocking connections 144A, 144B may refer to any suitable connection that allows captive retention therein of the outer and inner seals 130, 132 so that sealing engagement of the outer and inner seals 130, 132 with each other is achieved as the outer seal 130 and the inner seal 132 are pulled away from each other and as they are pushed towards each other while allowing disengagement of the outer and inner seals 130, 132 from each other in at least one configuration of the one or more interlocking connections 144A, 144B. In various embodiments, sealing engagement of the outer and inner seals 130, 132 with each other may either be direct engagement or engagement via an intermediate component. In various embodiments, the predetermined play of the one or more interlocking connections 144A, 144B may refer to any suitable range of allowable movement of the outer and inner seals 130, 132 relative to each other, while being captively retained in the one or more interlocking connections 144A, 144B, that includes movement disengaging the outer seal 130 from the inner seal 132 so as to open the cavity 136.

In some embodiments, the one or more interlocking connections 144A, 144B may interlock separate components by overlapping the components in two non-parallel directions. For example, the one or more interlocking connections 144A, 144B include interlocking curled or hooked components with each other.

In the embodiments shown in FIGS. 3A-3C, the one or more interlocking connections 144A, 144B include an interlocking connection between the outer seal 130 and a disc assembly 146 that is configured to captively retain the outer seal 130 between the housing 106 and the disc assembly 146.

As shown in FIGS. 3A-3C, the disc assembly includes an outer disc 148 (or outer retainer cap), an inner disc 150 (or inner retainer cap), and a middle disc 152 coupling the outer disc 148 and the inner disc 150 to each other. The outer disc 148 holds the outer seal 130 in place, while the inner disc 150 holds the inner seal 132 in place. The outer disc 148 may permanent retain the outer seal 130 in place while ensuring the outer seal 130 follows the piston rod 104 during the pressure phase. In various embodiments, the outer disc 148 and/or the inner disc 150 may be cap or cup shaped so as to receive cup seals for interlocking engagement therewith. For example, such retainer cups may open in opposite directions and define sidewalls suitable to engage with the seals. In some embodiments, the inner disc 150, the middle disc 152, and the outer disc 148 are rigidly integrally coupled to each other, e.g. by being threadably engaged with each other. In the embodiments of FIGS. 3A-3C, the inner disc 150, the middle disc 152, and the outer disc 148 arranged concentrically in series and are threadably engaged with each other along the longitudinal axis 122. The cavity 136 may be formed by serial arrangement or serially positioned portions of outer seal 130, the middle disc 152, and the inner seal 132. In various embodiments, the middle disc 152 may be configured to centralize the piston rod 104 in the housing 106. Advantageously, centralizing the piston rod 104 in the housing 106 may mitigate formation of unbalanced transverse loads (or side loads) due to operation of the piston rod 104. In some embodiments, such sideloads may serve to hinder sealing by the outer seal 130 and/or the inner seal 132.

In some embodiments, disc assembly 146 may be coupled to the piston rod 104 to allow an operator to actuate the piston assembly and seals thereof via the inner disc 150, the middle disc 152, and the outer disc 148. For example, the piston rod 104 may be concentrically arranged with one or more of the inner disc 150, the middle disc 152, and the outer disc 148, and threadably engaged therewith along the longitudinal axis 122. In various embodiments, a threaded fastener and washer fix the disc assembly 146 to an internally threaded plug at the end of the piston rod 104.

As shown in FIGS. 3A-3C, the outer disc 148 and the inner disc 150 have corresponding lips 154A, 154B that interlock with, respectively, the outer seal 130 and the inner seal 132.

In various embodiments, the disc assembly 146 may be constructed or composed of hard plastic, steel, aluminium, or other metal.

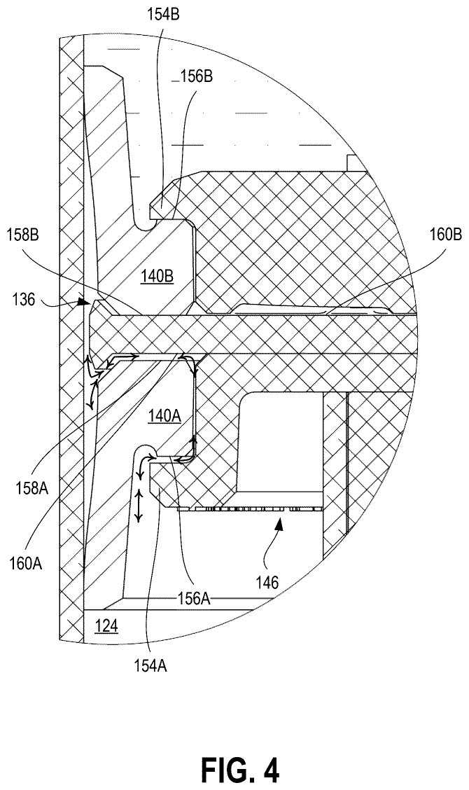

FIG. 4 is an enlarged cross-sectional view of the region 4 in FIG. 3B, in accordance with an embodiment.

In FIG. 4, the flow of the fluid (such as ambient air) and/or flow communication between spatially separated locations is schematically indicated by double-headed arrows.

As shown in FIG. 4, the cavity 136 is open so as to allow pressure equalization with the outer side 124. Each of the lips 140A, 140B define corresponding external faces 156A, 156B and corresponding internal faces 158A, 158B. The external faces 156A, 156B and the internal faces 158A, 158B are at least partially lateral to the longitudinal axis 122 and are suitable to form the one more interlocking connections 144A, 144B with predetermined play for coupling the outer and inner seals 130, 132 to each other. The external face 156A and the internal face 158A are opposite one another and form opposing faces of the lip 140A of the outer seal 130. Similarly, the external face 156B and the internal face 158B are opposite one another and form opposing faces of the lip 140B of the inner seal 132.

In some embodiments, as shown in FIG. 4, the inner disc 150 may be suitable for and adapted to engage with the external face 156B of the inner seal 132 during the pressure phase. Similarly, the outer disc 148 may be suitable for and adapted to engage with an external face 156A of the outer seal 130 during the suction phase.

In various embodiments, as shown in FIG. 4, the middle disc 152 is disposed between internal faces 158A, 158B. The middle disc 152 may provide sealing surfaces for the outer seal 130 and the inner seal 132. The middle disc 152 may seat the outer disc 148 and the inner disc 150. During the pressure phase, the middle disc 152 may engage with the internal face 158B of the inner seal 132 to at least partially sandwich the inner seal 132 between the inner disc 150 and the middle disc 152. During the suction phase, the middle disc 152 may engage with the internal face 158A of the outer seal 130 to at least partially sandwich the outer seal 130 between the outer disc 148 and the middle disc 152. In particular, the predetermined play in the interlocking connection 144B is in the form of a clearance between the middle disc 152 and the internal face 158A. In various embodiments, the outer disc 148 may be configured to allow sufficient deformation of the outer seal 130 to release sealing to remove a vacuum condition in the cavity 136, as described elsewhere.

As shown in FIG. 4, the disc assembly 146 is dimensioned so as to allow disengagement of the middle disc 152 from the outer seal 130 during the pressure phase. This permits ingress of fluid from the outer side 124 into the cavity 136 for pressure equalization as the applicator 100 is moved to the pressure phase by allowing movement of the outer seal 130 between the middle disc 152 and the outer disc 148.

In various embodiments, the lips 154A, 154B are suitable to engage with the external faces 156A, 156B. As a result, the lip 140A may be suitable to be sandwiched between the lip 154A and an outer face 160A of the middle disc 152 engaged with the internal face 158A. Similarly, the lip 140B may be suitable to be sandwiched between the lip 154B and an inner face 160B of the middle disc 152 engaged with the internal face 158B.

In some embodiments, the lip 140A is dimensioned relative to the outer disc 148 so as to be captively retained, with the predetermined play, between the outer face 160A and the lip 140A.

The movement of the disc assembly 146 away from the reservoir 118 during the suction phase causes sealing engagement of the outer face 160A with the internal face 158A to seal the cavity 136. Similarly, the movement of the disc assembly towards the reservoir during the pressure phase causes engagement of the lip 154A with the external face 156A. As such, the movement of the disc assembly 146 from the suction phase to the pressure phase causes disengagement of the lip 140A from the outer disc 148 and middle disc 152 to open the cavity 136 for pressure equalization. During this intermediate phase, there may be clearance between the outer seal 130 and the outer disc 148 on either side of the outer seal 130. Fluid may flow through a flow passage formed through this clearance, as shown in FIG. 4, for pressure equalization.

In some embodiments, the extension or width of the disc assembly 146, or a distance between internal faces of the lips 154A, 154B (between faces that engage with the seals) may be larger than the distance between external faces 156A, 156B.

In the embodiment of FIG. 4, there is predetermined play or clearance only between the outer seal 130 and the disc assembly 146, and no play or clearance between the inner seal 132 and the disc assembly 146.

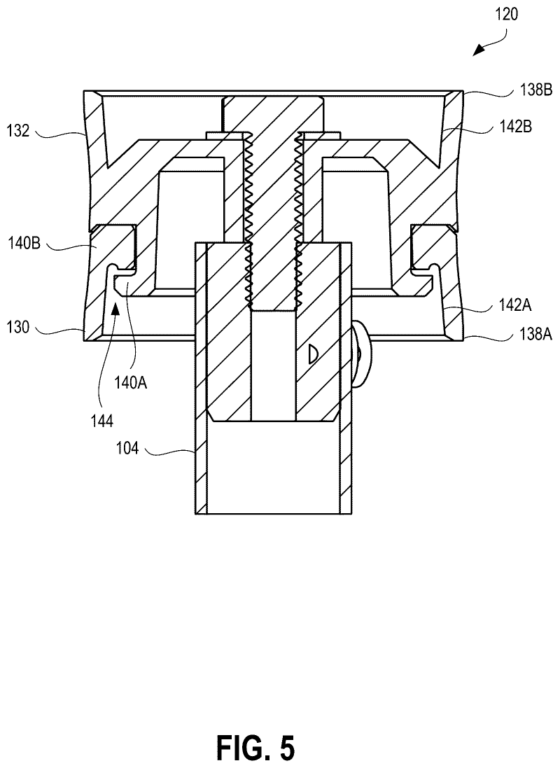

FIG. 5 is an enlarged cross-sectional view of a piston assembly 120, in accordance with another embodiment.

The embodiment of FIG. 5 does not have the disc assembly of the embodiments of FIGS. 3A-3C and FIG. 4.

In the embodiment shown in FIG. 5, the outer seal 130 and the inner seal 132 are disposed adjacent to one another to form the cavity 136 and are coupled to each other via a single interlocking connection 144. In particular, the outer seal 130 and the inner seal 132 are interlocked to captively retain each other. As such the outer seal 130 and the inner seal 132 are co-movable by movement of the piston rod 104 and are movable relative to each other to permit ingress of fluid for pressure equalization of the cavity 136 as the piston rod 104 is pushed into the housing 106 to move the applicator 100 to the pressure phase.

In the embodiment of FIG. 5, the inner seal 132 is directly coupled to the piston rod 104 and the outer seal is not directly coupled to the piston rod 104.

In various embodiments, the stiffness of the outer seal 130 and the inner seal 132 may be selected to allow deformation for pressure equalization while facilitating sealing. It is found to be particularly advantageous to allow deformation to achieve pressure equalization upon application of 100N of force via the piston rod 104.

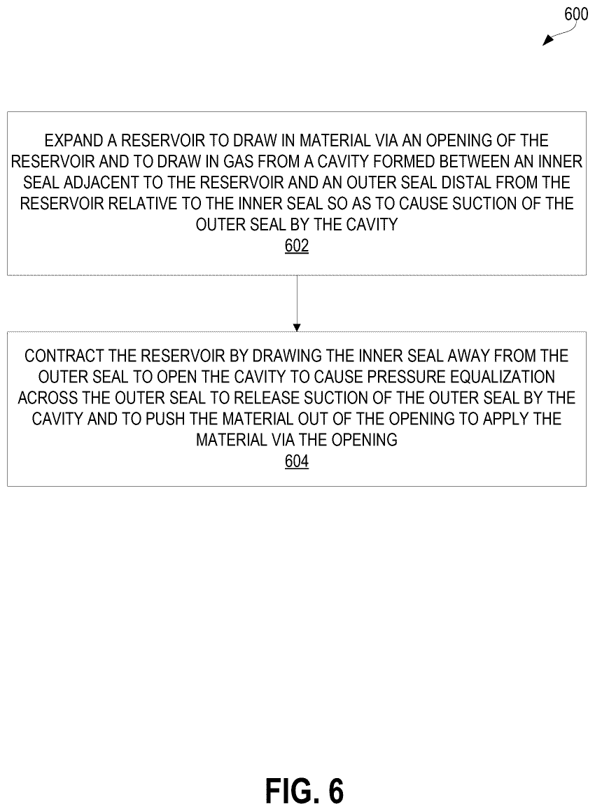

FIG. 6 is a flowchart of a method 600 of applying a material, in accordance with an embodiment.

Step 602 of the method 600 includes expanding a reservoir to draw in the material via an opening of the reservoir and to draw in fluid from a cavity formed between an inner seal adjacent to the reservoir and an outer seal distal from the reservoir relative to the inner seal so as to cause suction of the outer seal by the cavity.

Step 604 of the method 600 includes contracting the reservoir by drawing the inner seal away from the outer seal to open the cavity to cause pressure equalization across the outer seal to release suction of the outer seal by the cavity and to push the material out of the opening to apply the material via the opening.

In some embodiments of the method 600, the outer seal is a first piston cup seal, and the inner seal is a second piston cup seal.

In some embodiments of the method 600, the inner and outer seals are spaced apart from each other and coupled to each other via a disc assembly, and wherein contracting the reservoir by drawing the inner seal away from the outer seal includes pushing the inner seal away from the outer seal using a middle disc of the disc assembly to open the cavity.

Some embodiments of the method 600 include retaining, captively, the outer seal between the middle disc and an outer disc of the disc assembly so as to allow movement of the outer seal, the outer disc being coupled to the middle disc.

Some embodiments of the method 600 include interlocking the inner and outer seals with predetermined play between the inner and outer seals, and wherein contracting the reservoir by drawing the inner seal away from the outer seal includes displacing the inner and outer seals relative to each other to open the cavity to cause pressure equalization.

As can be understood, the examples described above and illustrated are intended to be exemplary only.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, additional seals may be provided, and the piston rod may be actuated by a mechanical device. Yet further modifications could be implemented by a person of ordinary skill in the art in view of the present disclosure, which modifications would be within the scope of the present technology.

The term “connected” or “coupled to” may include both direct coupling (in which two elements that are coupled to each other contact each other) and indirect coupling (in which at least one additional element is located between the two elements).

What is claimed is:

1. An applicator for applying a material, comprising:
a housing defining an opening for receiving and extruding the material; and
a piston assembly movably engaged within the housing to form a reservoir that is expandable to draw the material into the reservoir via the opening during a suction phase and that is contractable to push material out of the reservoir via the opening during a pressure phase, the piston assembly including
an outer seal to prevent ingress of fluid towards the reservoir from an outer side of the piston assembly in the housing opposite the reservoir, during the suction phase,
an inner seal disposed between the outer seal and the reservoir to prevent egress of material out of the reservoir into a cavity formed between the housing and the inner and outer seals, during the pressure phase,
a piston rod to actuate the piston assembly and operatively associated with the inner and outer seals, the piston rod being operable to close the cavity by the outer seal during the suction phase to allow suction of the outer seal by the cavity, the piston rod being operable to move relative to the outer seal as the applicator is moved to the pressure phase to open the cavity to the outer side for pressure equalization of the cavity to prevent suction of the outer seal by the cavity during the pressure phase.

2. The applicator of claim 1, wherein the piston assembly is configured to couple the inner and outer seals to each other via one or more interlocking connections with predetermined play so as to open the cavity between the inner and outer seals as the piston assembly is moved from the suction phase to the pressure phase to allow flow communication between the outer side and the cavity and so as to close the cavity between the inner and outer seals during the suction phase to allow suction of the outer seal by the cavity.

3. The applicator of claim 2, wherein the one or more interlocking connections includes an interlocking connection between the outer seal and a disc assembly configured to captively retain the outer seal between the housing and the disc assembly, the disc assembly being coupled to the piston rod, the piston rod extending outwardly from the housing to allow an operator to actuate the piston assembly to achieve the pressure phase by pushing on the piston rod and to achieve the suction phase by pulling on the piston rod.

4. The applicator of claim 3, wherein the disc assembly includes
an inner disc suitable to engage with an external face of the inner seal during the pressure phase,
an outer disc suitable to engage with an external face of the outer seal during the suction phase, and
a middle disc coupling the inner and outer discs to each other and disposed between internal faces of the inner and outer seals to engage with the internal face of the inner seal during the pressure phase to at least partially sandwich the inner seal between the inner disc and the middle disc and to engage with the internal face of the outer seal during the suction phase to at least partially sandwich the outer seal between the outer disc and the middle disc, the disc assembly being dimensioned so as to allow disengagement of the middle disc from the outer seal as the applicator is moved to the pressure phase to allow movement of the outer seal between the middle disc and the outer disc to permit ingress of fluid into the cavity for pressure equalization.

5. The applicator of claim 4, wherein the external and internal faces of the inner seal are opposing faces of a lip of the inner seal, the external and internal faces of the outer seal are opposing faces of a lip of the outer seal, a lip of the inner disc engages with the external face of the inner seal such that the lip of the inner seal is suitable to be sandwiched between the lip of the inner disc and an inner face of the middle disc engaged with the internal face of the inner seal, a lip of the outer disc engages with the external face of the outer face such that the lip of the outer seal is suitable to be sandwiched between the lip of the outer disc and an outer face of the middle disc engaged with the internal face of the outer seal, and wherein the lip of the outer seal is dimensioned relative to the outer disc so as to be captively retained, with the predetermined play, between the outer face of the middle disc and the lip of the outer disc.

6. The applicator of claim 5, wherein the inner disc, the middle disc, and the outer disc are rigidly integrally coupled to each other, the movement of the disc assembly away from the reservoir during the suction phase causing sealing engagement of the outer face of the middle disc with the internal face of the outer seal to seal the cavity, the movement of the disc assembly towards the reservoir during the pressure phase causing engagement of the lip of the outer disc with the external face of the outer seal, such that movement of the disc assembly from the suction phase to the pressure phase causes disengagement of the lip of the outer seal from the outer and middle discs to open the cavity for pressure equalization.

7. The applicator of claim 1, wherein the inner seal is a first piston cup seal and the outer seal is a second piston cup seal, a cup depression of the first piston cup seal positioned to receive the material to achieve sealing by pressurization of the cup depression of the first piston cup seal during the pressure phase, a cup depression of the second piston cup seal positioned to receive fluid from the outer side of the piston assembly to achieve sealing by pressurization of the cup depression of the second piston cup seal during the suction phase.

8. The applicator of claim 1, wherein the inner and outer seals each have a corresponding external end suitable to sealingly engage with the housing, the inner and outer seals extending radially inwardly and towards each other from the corresponding external ends to form the cavity between the housing and the inner and outer seals and to allow pressure applied to sidewalls of the inner and outer seals opposite the cavity to vary sealing of the corresponding external ends of the inner and outer seals against the housing.

9. The applicator of claim 8, wherein the inner and outer seals extend smoothly concavely towards each other from their external ends to form the cavity between the housing and the inner and outer seals.

10. The applicator of claim 1, wherein the piston rod extends outwardly from the housing to allow an operator to actuate the piston assembly to achieve the pressure phase by pushing on the piston rod and to achieve a suction phase by pulling on the piston rod, the housing being elongated between a first end and a second end, the opening of the housing disposed at the first end, a cap closing the housing disposed at the second end and configured to receive the piston rod to allow slidable movement of the piston rod in the cap.

11. The applicator of claim 1, wherein the inner seal is coupled to the piston rod, the piston rod extending outwardly from the housing to allow an operator to actuate the piston assembly to achieve the pressure phase by pushing on the piston rod and to achieve the suction phase by pulling on the piston rod, and the inner and outer seals are disposed adjacent to one another to form the cavity and are interlocked to captively retain each other such that the inner and outer seals are co-movable by movement of the piston rod and are movable relative to each other to permit ingress of fluid for pressure equalization of the cavity as the piston rod is pushed into the housing.

12. The applicator of claim 1, wherein the material is drywall compound, and the opening is an aperture coupled to a finishing tool suitable to shape the drywall compound being extruded from the aperture.

13. The applicator of claim 1, wherein the inner and outer seals are concentrically arranged in series about a longitudinal axis of the housing and retained within the housing by frictional engagement with an inner surface of the housing, the inner and outer seals extending radially inwardly and longitudinally towards each other from a corresponding external ends towards corresponding circumferentially and radially inwardly extending lips to form the cavity, each of the corresponding circumferentially and radially inwardly extending lips defining corresponding internal and external faces at least partially lateral to the longitudinal axis and suitable for forming one or more interlocking connections with predetermined play for coupling the inner and outer seals to each other so as to open the cavity as the piston assembly is moved from the suction phase to the pressure phase to allow flow communication between the outer side and the cavity.

14. A method of applying a material, comprising:
expanding a reservoir to draw in the material via an opening of the reservoir and to draw in fluid from a cavity formed between an inner seal adjacent to the reservoir and an outer seal distal from the reservoir relative to the inner seal so as to cause suction of the outer seal by the cavity; and
contracting the reservoir by drawing the inner seal away from the outer seal to open the cavity to cause pressure equalization across the outer seal to release suction of the outer seal by the cavity and to push the material out of the opening to apply the material via the opening.

15. The method of claim 14, wherein the outer seal is a first piston cup seal, and the inner seal is a second piston cup seal.

16. The method of claim 14, wherein the inner and outer seals are spaced apart from each other and coupled to each other via a disc assembly, and wherein contracting the reservoir by drawing the inner seal away from the outer seal includes pushing the inner seal away from the outer seal using a middle disc of the disc assembly to open the cavity, and further comprising:
retaining, captively, the outer seal between the middle disc and an outer disc of the disc assembly so as to allow movement of the outer seal, the outer disc being coupled to the middle disc.

17. The method of claim 14, further comprising interlocking the inner and outer seals with predetermined play between the inner and outer seals, and wherein contracting the reservoir by drawing the inner seal away from the outer seal includes displacing the inner and outer seals relative to each other to open the cavity to cause pressure equalization.

18. A piston assembly for an applicator for applying material, the applicator having a housing defining an opening for receiving and extruding the material from a reservoir formed in the housing, the reservoir being expandable to draw the material into the reservoir via the opening during a suction phase of the applicator and being contractable to push material out of the reservoir via the opening during a pressure phase of the applicator, the piston assembly comprising:
an outer seal to prevent ingress of fluid towards the reservoir from a side of the housing opposite the reservoir relative to the piston assembly, during the suction phase; and
an inner seal disposed between the outer seal and the reservoir to prevent egress of material out of the reservoir into a cavity formed between the housing and the inner and outer seals, during the pressure phase, the outer seal being at least partially freely movable as the applicator is being moved to the pressure phase to open the cavity between the inner and outer seals to allow flow communication between the side of the housing and the cavity for pressure equalization of the cavity to prevent suction of the outer seal by the cavity during the pressure phase and being configured to close the cavity between the inner and outer seals during the suction phase to allow suction of the outer seal by the cavity.

19. The piston assembly of claim 18, wherein the inner seal and outer seals are adapted to interlock with each other with predetermined play between the inner and outer seals so as to open the cavity between the inner and outer seals as the applicator is moved from the suction phase to the pressure phase to allow flow communication between the side and the cavity, and so as to close the cavity between the inner and outer seals during the suction phase to allow suction of the outer seal by the cavity.

20. The piston assembly of claim 18, wherein the inner and outer seals each have a corresponding external end suitable to sealingly engage with the housing, the inner and outer seals are piston cup seals extending radially inwardly and towards each other from their corresponding external ends to form the cavity between the housing and the inner and outer seals.

21. The piston assembly of claim 18, wherein the inner and outer seals are coupled to each other via one or more interlocking connections with predetermined play to open the cavity as the applicator is moved from the suction phase to the pressure phase to allow flow communication between the side and the cavity, the one or more interlocking connections including an interlocking connection between the outer seal and a disc assembly configured to captively retain the outer seal between the housing and the disc assembly, the disc assembly being coupled to a piston rod extending outwardly from the housing to allow an operator to actuate the applicator to achieve the pressure phase by pushing on the piston rod and to achieve the suction phase by pulling on the piston rod.

22. The piston assembly of claim 18, wherein the inner seal is a first piston cup seal and the outer seal is a second piston cup seal, a cup depression of the first piston cup seal positioned to receive the material to achieve sealing by pressurization of the cup depression of the first piston cup seal ring the pressure phase, a cup depression of the second piston cup seal positioned to receive fluid from the side to achieve sealing by pressurization of the cup depression of the second piston cup seal during the suction phase.
